(19) United States
(12) Patent Application Publication
(10) Pub. No.: US 2012/0253914 A1
(43) Pub. Date: Oct. 4, 2012

(54) UNIVERSAL LOYALTY PROGRAM DEVICE

(75) Inventor: Jeremy Black, Foster City, CA (US)

(73) Assignee: VISA INTERNATIONAL SERVICE ASSOCIATION, San Francisco, CA (US)

(21) Appl. No.: 13/432,249

(22) Filed: Mar. 28, 2012

Related U.S. Application Data
(60) Provisional application No. 61/469,002, filed on Mar. 29, 2011.

(51) Int. Cl. G06Q 30/02

(52) U.S. Cl. 705/14.28

(57) ABSTRACT

A universal loyalty device (e.g., fob) associated with multiple loyalty programs. The universal loyalty fob could be in the form of a card, or another form factor. A user may register several existing loyalty programs/cards and payment cards with the universal loyalty fob, which can be scanned at a POS terminal. A third party may manage all the loyalty data through the universal loyalty fob, and may provide real-time discounts at the POS terminal. The universal loyalty fob may also be used to redeem points or rewards towards a purchase. Additionally, all recorded purchase and loyalty data may be made available to participating merchants. This data may be used to evaluate competitor merchants' market share or evaluate the efficacy of specific merchants' loyalty programs.

### RELATED APPLICATIONS

The present application claims priority to U.S. Provisional Patent Application Ser. No. 61/469,002, filed Mar. 29, 2011, entitled “Universal Loyalty FOB”, the disclosure of which is incorporated herein by reference.

### BACKGROUND

Loyalty programs associated with participating merchants to provide incentives for goods or services are very common to entice consumers. Typically loyalty programs will issue a loyalty program card or key fob to the consumer, for use during a transaction at a participating merchant. Different loyalty programs with different participating merchants and incentives will issue different loyalty program cards or key fobs, inundating the consumer with multiple cards and key fobs for multiple loyalty programs. In order for the consumer's transactions to be accounted towards their respective loyalty programs, the consumer needs to use the loyalty program card or key fob to record the loyalty transaction, and also a payment card to pay for the transaction.

### BRIEF SUMMARY

An improved system for implementing a universal loyalty program is needed to reduce the amount of cards, clutter, key fobs, and other devices for consumers, as well as to streamline and automate the operations involved in processing a loyalty and a payment transaction.

Embodiments of the disclosure are related to an improved method of implementing a universal loyalty program. The universal loyalty program, or any loyalty program described herein, may be a membership program in which users may become members of to participate in loyalty transactions with participating merchants. In an embodiment, a universal loyalty device may be issued to a user, wherein the user may register multiple loyalty programs with the universal loyalty program to replace multiple loyalty program devices (e.g., cards or key fobs).

In another embodiment, a platform for a universal loyalty program with a universal loyalty program account and/or device is implemented to significantly simplify loyalty or payment transactions into one transaction occurring at the point of sale at a participating merchant. Both loyalty and payment transactions may be recorded and updated at the same time, automatically determining what loyalty program(s) are eligible based on the transaction.

### BRIEF DESCRIPTION OF THE DRAWINGS

FIG. 1 shows a block diagram illustrating a system according to an embodiment of the disclosure.

FIG. 2 shows a flowchart illustrating a method according to an embodiment of the disclosure.

FIG. 3 shows a user interface according to an embodiment of the disclosure.

FIG. 4 shows a block diagram illustrating a system of an exemplary universal loyalty program according to an embodiment of the disclosure.

FIG. 5(a) and FIG. 5(b) show exemplary universal loyalty program devices according to embodiments of the disclosure.

FIG. 5(c) shows exemplary devices in a system according to an embodiment of the disclosure.

FIG. 6 shows a block diagram illustrating components in a computer apparatus according to an embodiment of the disclosure.

### DETAILED DESCRIPTION

### I. Overview

Embodiments relate to the idea of using a universal loyalty device with multiple loyalty program accounts associated with it. The universal loyalty device could be in the form of a card, or other form factor. In one example, the universal loyalty device may have many bar codes, which can be scanned at the point of sale. A payment processing network, such as VisaNet, may manage the loyalty data for the individual loyalty programs. If loyalty programs are managed by the payment processing network, real time discounts can be provided to users of the loyalty programs at the point-of-sale. Making loyalty or purchase transactions using the universal loyalty device managed by the payment processing network also allows the payment processing network to provide data to merchants regarding how competitor merchants are doing, user activity, and sales.

Additionally, in another embodiment, the universal loyalty device may be a payment device. Therefore, when conducting a transaction using the universal loyalty device, the user may select to use loyalty points, rewards, or promotions to complete the transaction, or use the universal loyalty device as the payment device. This eliminates the need for the user to carry both a loyalty device and a payment device.

In another embodiment, a user may register a number of different loyalty cards and payment cards on a website operated by the universal loyalty program. The user may link one or more payment cards to one or more loyalty cards, so that when the user uses a payment card at a participating merchant, loyalty points are automatically given to the consumer to the associated loyalty card and account balances can be updated to the payment card. For example, the user may register a Best Buy loyalty card, a Safeway Loyalty card, a Chase credit card, and a Wells debit card. The consumer may then selectively link both of the payment cards to both of the loyalty cards. When the consumer shops at Best Buy with his Chase card, an authorization message is sent to Visa and Visa then determines that the transaction came from Best Buy and updates the Best Buy loyalty account accordingly.

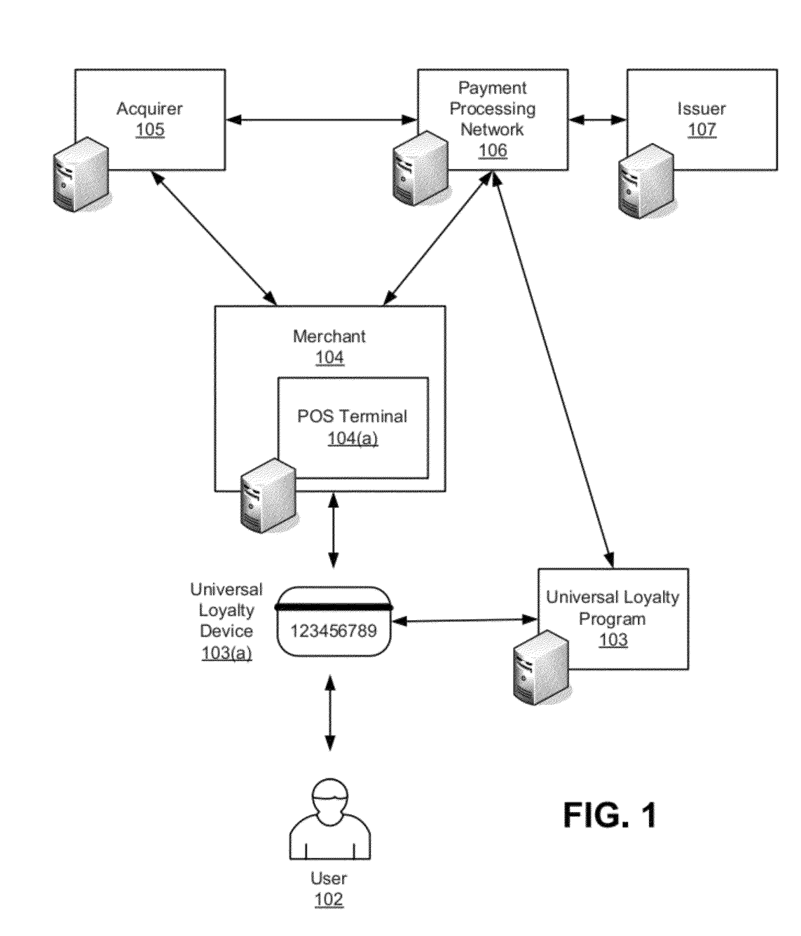

FIG. 1 shows a block diagram illustrating a system where a user 102, being a member of several different loyalty programs associated with different participating merchants, may want to register to become a member of and participate in an universal loyalty program 103. The operator of the universal loyalty program 103 may issue a universal loyalty device 103(a) to the user 102. This device 103(a) may include a key fob, a card, or a payment card. The operator of the universal loyalty program 103 may be a payment processing network 106, such as VisaNet, or in other embodiments may be a third party that communicates directly with the payment processing network 106.

The user 102 may present the universal loyalty device 103(a) to a merchant 104 to conduct a transaction at a point-of-sale terminal 104(a). The transaction may also be conducted at a POS terminal at a store in-person, online, or over the telephone. The merchant 104 may be operatively coupled to an acquirer 105 and the payment processing network 106 (e.g., VisaNet).

The merchant 104 may communicate with both the acquirer 105 and the payment processing network 106 to request confirmation of the desired transaction by the user 102. The payment processing network 106 and the acquirer 105 may also communicate with each other after receiving the request from the merchant 104 to secure an amount for which the user 102 would like to make as a payment to the merchant 104. The payment processing network 106 may communicate with an issuer 107 to confirm and authorize the desired payment transaction for the user 102. When the payment transaction has been authorized, the payment processing network 106 may communicate with the acquirer 105 and the merchant 104. To automatically update universal loyalty balances, individual loyalty balances, and account balances, the payment processing network 106 may communicate directly with the universal loyalty program 103 and transmit associated transaction data.

### II. Enrollment Process

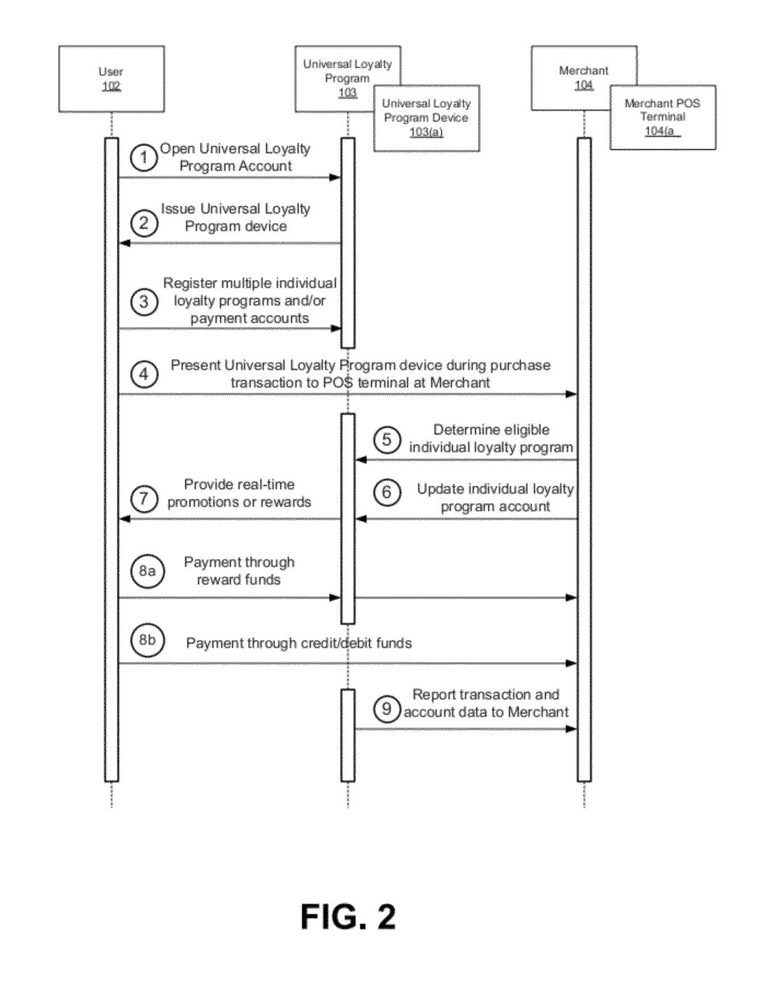

FIG. 2 shows a flowchart diagram of embodiments of the disclosure.

(1) Prior to conducting a transaction, a user may first enroll to become a member of a universal loyalty program 103. The user 102 may open a universal loyalty program account with a universal loyalty program 103, operated by a payment processing network (e.g., VisaNet) or an independent third party coupled to the payment processing network. Opening a universal loyalty program account may involve providing the universal loyalty program 103 with user 102 information, and may be conducted by filling out information request forms online, by telephone, or by mail. In some embodiments the user may be automatically enrolled through other services or promotions.

(2) When the user 102 has opened the universal loyalty program account, the user 102 may receive a loyalty program account identifier. In some embodiments, the universal loyalty program may issue a universal loyalty program device 103(a). The universal loyalty program device 103(a) may be unique to the user 102 and may contain the universal loyalty program account identifier. The universal loyalty program device 103(a) may comprise hardware and software components capable of storing information, transmitting or receiving data, and/or communicating with merchant 104 point-of-sale terminals 104(a). In other embodiments, the universal loyalty program device 103(a) may be a passive device (e.g., a card with multiple barcodes on it).

(3) The user 102 may register multiple existing loyalty programs associated with multiple merchants that the user is already participating in. Registering loyalty programs may comprise entering other loyalty program account identifiers, username or login information, and other loyalty program membership information. This information may be collected via an online request form on a website with a secure login or by any other secured means. In other embodiments, the user 102 may also register payment accounts or devices, such as payment cards (e.g., credit cards, debit cards, charge cards), gift cards, or other account devices with monetary value. In embodiments of the disclosure where a separate designated universal loyalty program device is not issued, any one of the payment devices registered with the universal loyalty program may effectively operate as the universal loyalty program device, or the universal loyalty program account identifier may effectively be a virtual universal loyalty program device.

### III. Transaction Process

(4) When the user 102 wishes to make a purchase transaction at a merchant 104, the user 102 may present the universal loyalty program device 103(a) (e.g., a separate universal loyalty device, or any payment device registered with the universal loyalty program) at the point-of-sale. The merchant 104 may scan, swipe, or enter the universal loyalty program device 103(a) or account identifier into a POS terminal 104(a).

(5) When the universal loyalty device 103(a) is scanned or the universal loyalty account identifier is entered at the POS terminal 104(a), a message may be sent from the POS terminal 104(a) at the merchant 104 to the universal loyalty program 103 operated by, or in communication with, a payment processing network 106 (not shown). The message may be sent via any suitable network interface, and may contain transaction information, universal or individual loyalty program information, and user information. Based on information in the message, the universal loyalty program 103 may access universal loyalty account information (e.g., individual loyalty programs and payment devices registered) associated with the universal loyalty device 103(a) or universal loyalty account identifier to determine eligibility of individual loyalty programs registered with the universal loyalty program account. The universal loyalty program 103 may receive and transmit loyalty and payment transaction data with the payment processing network, such as VisaNet. The universal loyalty program 103 and merchant 104 may be coupled via a network interface.

In one embodiment, a separate loyalty program is among the loyalty programs that are registered with the universal loyalty program device. The separate loyalty program is hosted, separated from the universal loyalty program, on a platform, such as a system of a third party loyalty program provider or the merchant 104. Some of the users enrolled in the separate loyalty program may not register with the universal loyalty program 103. Since the user 102 presents 4 the universal loyalty program device to indicate the membership in loyalty programs, the merchant POS terminal 104(a) is configured to communicate with the universal loyalty program 103 to determine whether the user 102 is a member in the separate loyalty program. Since the user 102 has registered to associate the membership of the user 102 with the separate loyalty program with the universal loyalty device 103(a) of the user 102, the universal loyalty program 103 identifies the membership of the user 102 with the separate loyalty program for the determination 5 of the eligible individual loyalty program. Thus, the merchant POS terminal 104(a) can subsequently communicate with the system of the third party loyalty program provider or the merchant 104 that runs the separate loyalty program to provide benefits to the user 102. Further, if the user 102 makes a purchase from the merchant 104, the merchant POS terminal 104(a) is configured to communicate the purchase details to the universal loyalty program to determine eligibility of benefits under other loyalty programs registered to be associated with the universal loyalty device 103(a). Based on the purchase details, the universal loyalty program 103 may communicate with a further separate loyalty program to provide the loyalty benefit to the user 102 of the universal loyalty device 103(a). For example, when the user 102 is a member of a loyalty program provided by a manufacturer, the purchase of a product of the manufacture from the merchant 104 may entitle the user 102 to certain benefits in the loyalty program provided by the manufacturer.

(6) Based on data from the transaction, the individual loyalty program accounts associated with the universal loyalty program account identifier or device may be automatically updated (e.g., wirelessly). In an embodiment of the disclosure, the update may occur at the merchant or merchant POS terminal, and/or the universal loyalty program simultaneously to ensure consistent information. In other embodiments, account balances and loyalty program updates may occur with the payment processing network operating the universal loyalty program. Transaction data used to determine eligibility may comprise data such as participating merchant, items or services purchased, or other loyalty/reward parameters. Updates may be made directly to the universal loyalty program device 103(a) or universal loyalty program account, and may include updating loyalty or point funds, determining if a reward has been redeemed, and providing new rewards and promotions specifically targeted to the user 102 activity.

(7) The targeted new rewards and promotions generated by the universal loyalty program 103 may be provided to the user 102 in real-time via the merchant POS terminal 104(a) communicating with the universal loyalty program device 103(a). In other embodiments, the new rewards or promotions generated may be provided from the universal loyalty program 103 in collaboration with the merchant 104 to provide specific incentives to the user 102 for the specific merchant 104. The user 102 may choose to exercise the new reward or promotion, or reserve the reward for another time.

(8a) In one embodiment of the disclosure, the user 102 may use rewards or point funds to complete the purchase transaction and make a payment to the merchant 104. The universal loyalty program device 103(a) may communicate with the merchant POS terminal 104(a) to directly deduct the rewards or points from the universal loyalty program account or a specific individual loyalty program account as payment to the merchant 104.

(8b) In another embodiment of the disclosure, the user 102 may complete the purchase transaction by making a payment using a payment account device, such as a credit or debit card. The payment device may be already registered and associated with the universal loyalty program account during the enrollment process. In other embodiments of the disclosure, the payment card may be the universal loyalty program device 103(a).

(9) When the payment transaction is complete, the universal loyalty program 103 may generate and provide reports of the user's transaction and account activity to the participating merchant 104. The merchant 104 may use the reports to extrapolate data for marketing and advertising purposes, or other business purposes. The reports may be used for analysis and tracking of transaction trends, transactions with other competing merchants, user loyalty, and user rewards.

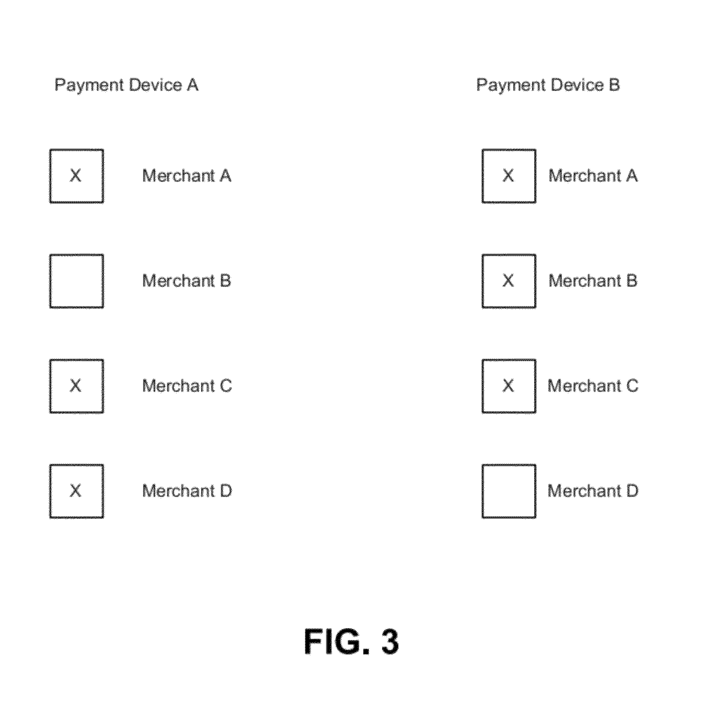

FIG. 3 illustrates an embodiment of the disclosure in which a user may register several payment devices, such as Payment Device A and Payment Device B, with the universal loyalty program. The user may be a participant of multiple individual loyalty programs associated with individual merchants, and the individual loyalty programs may also be registered with the universal loyalty program. Merchants A-D may have their own individual loyalty programs. The user can selectively link Merchants A-D, and their associated loyalty programs, to specific payment devices (A or B). For example, in FIG. 3, Merchant A, C, and D are linked to Payment Device A. Merchant A, B, and C are linked to Payment Device B.

When the user uses Payment Device A at Merchant A, C, or D, the transaction is processed by a payment processing network (e.g., Visa Net), which communicates with the universal loyalty program so the loyalty accounts associated with Merchants A, C, or D are automatically updated. Alternatively, if the user uses Payment Device B at Merchant A, B, or C, the payment processing network and universal loyalty program communicate with each other so that the loyalty accounts associated with Merchants A, B, or C are automatically updated. Since Merchant C has been linked to both Payment Device A and Payment Device B, the user may use either payment device at Merchant C, and the loyalty program account associated with Merchant C will be automatically updated.

For example, Payment Device A may be a corporate credit card, and the user may select an airline company as Merchant A, a restaurant as Merchant C, and a hotel as Merchant D. Thus, if the user needs to book a flight with Merchant A, make a restaurant or hotel reservation with Merchant C and D, respectively, for a business trip, the user may use Payment Device A, the corporate credit card, to accumulate such points towards their respective loyalty accounts (e.g., airline, restaurant, and hotel). Additionally, the user may go to the restaurant (Merchant C) or book a flight with the airline company (Merchant A) for personal reasons and thus would not use the corporate credit card (Payment Device A), but the user's personal credit card (Payment Device B).

The selective linking may be performed by the user during enrollment on an online request form on a website for the universal loyalty program operated by a payment processing network or a third party operatively coupled to the payment processing network. The user may selectively link a plurality of loyalty cards or accounts with a plurality of payment devices, each payment device having at least one associated loyalty program account with a merchant linked to it. Thus, when the payment device is used in a transaction and the payment processing network authorizes the transaction, the linked loyalty program account is automatically updated simultaneously.

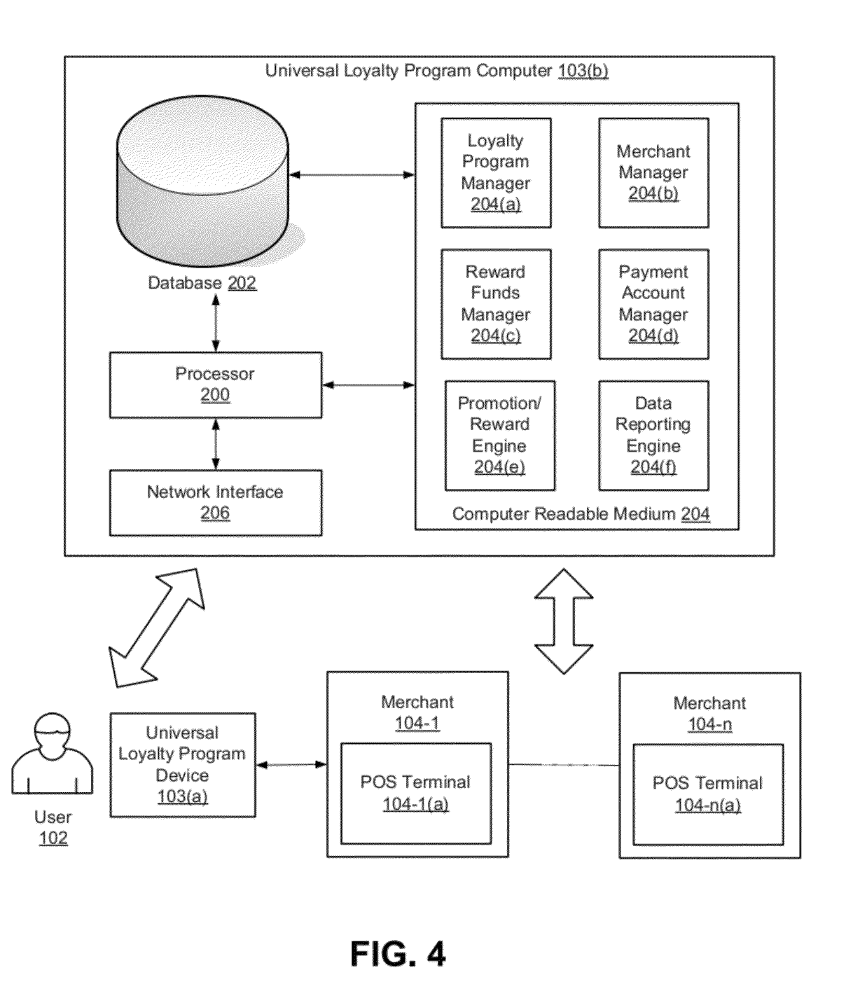

FIG. 4 shows a block diagram of a universal loyalty program computer 103(b) according to embodiments of the disclosure capable of the operations described above and shown in FIG. 2. The universal loyalty program server computer apparatus may comprise both hardware and software components, including a processor 200, and a computer readable medium 204 comprising code capable of being executed by the processor 200. The code stored in the computer readable medium may comprise software modules designed to perform functions of the universal loyalty program 103.

The computer readable medium 204 may comprise a loyalty program manager 204(a), which may communicate with a database 202 to register, enroll, store, identify and manage the individual loyalty programs entered by the user 102. The loyalty program manager 204(a) may also enable the user 102 to add or remove loyalty programs. Each of the individual loyalty programs are associated with an individual participating merchant. Thus the computer readable medium 204 may also comprise a merchant manager 204(b) to track, update, and identify participating merchants and their corresponding loyalty programs. During a purchase transaction made by a user 102 with a merchant 104 within a plurality of merchants 104-n, the loyalty program manager 204(a) and merchant manager 204(b) may determine the eligible loyalty program and participating merchant associated with the purchase transaction.

A rewards fund manager 204(c) may store and update reward eligibility, points funds and credits associated with the individual loyalty programs, and also the universal loyalty program based on the purchase transaction. In some embodiments of the disclosure, the rewards fund manager 204(c) may determine if the user 102 has sufficient rewards for redemption to conduct a payment for the purchase transaction.

In other embodiments of the disclosure, the purchase transaction may be completed using a payment card or account to make the payment. A payment account manager 204(d) may process the payment with the desired payment account. The payment account manager 204(d) may register, enroll, store, identify, and manage individual payment accounts entered by the user 102.

To determine new targeted rewards or promotions in real-time at the point-of-sale, the computer readable medium 204 of the universal loyalty program 103 may comprise a promotion/reward engine 204(e). The promotion/reward engine 204(e) may analyze the transaction to determine rewards customized to the user 102 based on transaction and account history.

The transaction and account history of the user 102 may be saved in the database 202 accessed by a data reporting engine 204(f) to generate reports to the merchants 104 for marketing, advertising, and other business purposes. The data reporting engine 204(f) may process and analyze transaction data to generate the reports relevant to the merchants 104-n.

The universal loyalty program 103 may comprise a network interface 206 to communicate with the user 102 and merchants 104-n. The user 102 may use the universal loyalty program device 103(a) to communicate with a POS terminal 104(a) at a merchant 104. The merchant 104 may be coupled to the universal loyalty program 103 through a communications network, and may transmit and receive data via the universal loyalty program's network interface 206. The user may also communicate with the universal loyalty program 103 through the network interface 206 to register multiple individual loyalty programs, update information, view individual loyalty program funds, and add/remove individual loyalty programs.

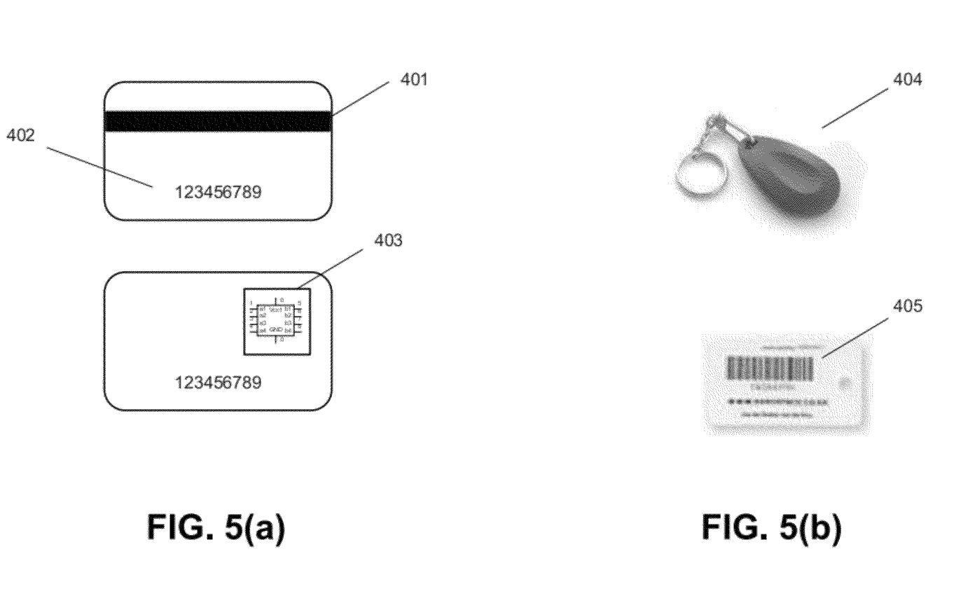

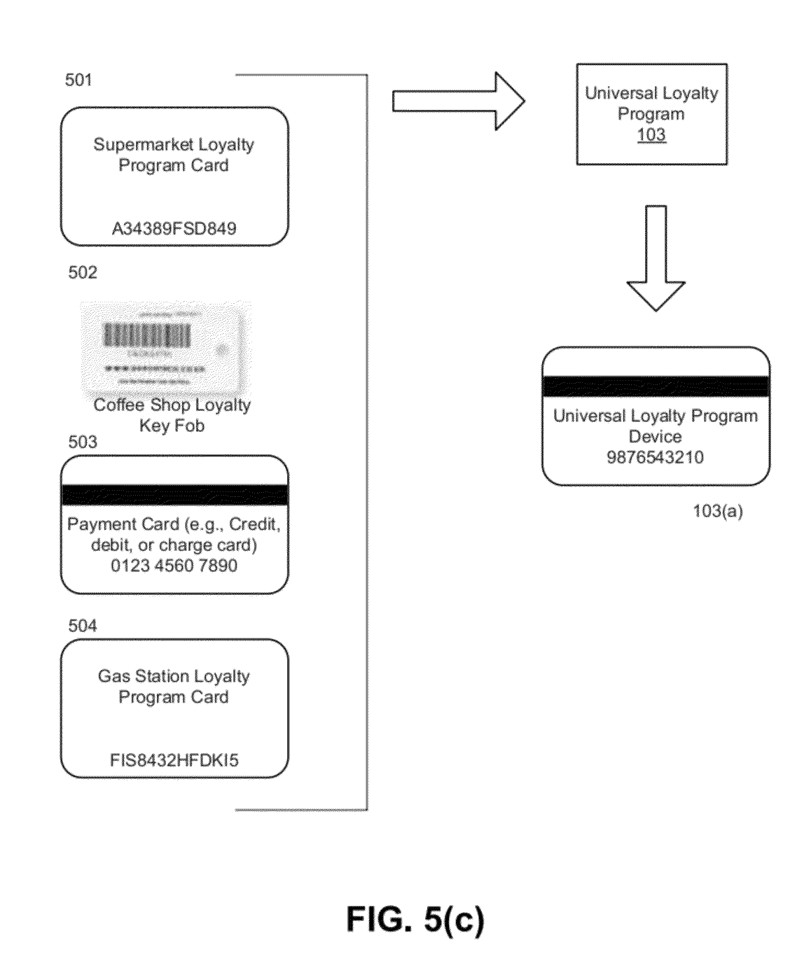

FIG. 5(a) and FIG. 5(b) are exemplary universal loyalty program devices. They may be in the form of a card, as shown in FIG. 5(a), and may comprise a magnetic (MICR) stripe 401, universal loyalty program account identifier 402, and RFID or other semiconductor circuit 403 capable of storing, transmitting, and receiving data (e.g., barcode). FIG. 5(b) shows a key fob, which may be attached to a keychain for convenience to the user. The key fob may be an electronic device 404 comprising electronics capable of storing, transmitting, and receiving data, and may be enabled to communicated wirelessly with a merchant POS terminal 104(a). In other embodiments the key fob may comprise a barcode 405 capable of being scanned at a POS terminal.

### IV. Advantages

Embodiments of the disclosure have many advantages. The user no longer needs to carry, present, or use a separate payment device and a loyalty device for each loyalty program or participating merchant when conducting a purchase transaction. Only one universal loyalty program device or payment card needs to be used in order to automatically update the applicable loyalty programs, as shown in FIG. 5(c). Multiple different loyalty programs associated with different merchants issuing different loyalty program devices (501, 502, 503, 504) may be registered with the universal loyalty program 103 to issue a single universal loyalty program card 103(a) that is inclusive of all the individual loyalty program devices. Examples of individual loyalty programs that the user may already be a member of are shown in FIG. 5(c), such as a supermarket loyalty program card 501, a coffee shop loyalty program key fob with a bar code 502, a payment device (e.g., credit card) 503, or gas station loyalty program card with an account identifier 504. According to embodiments of the disclosure, it is not necessary for the user to carry all 4 devices (501-504), but can simply carry one device, the universal loyalty program device 103(a).

In other embodiments of the disclosure, the universal loyalty program device 103(a) may be a payment device that is already registered to the universal loyalty program 103, for example, payment device 503. Thus, a separate universal loyalty program device 103(a) may not be necessary for the user to carry or present to a merchant at the point of sale. The user may use the payment device 503, which has already been linked to the universal loyalty program and the individual loyalty programs on the universal loyalty program account, so that in a transaction with registered payment device 503, account balances on the payment device 503, and loyalty balances on individual loyalty programs linked to the payment device 503 may be automatically updated. This is advantageous for users and universal loyalty program operators (e.g., payment processing network such as VisaNet) because a separate universal loyalty device may not need to be issued; the universal loyalty device may be a device that is already present in the users' wallet and can serve as both a payment and loyalty device.

Additionally, the user does not need to determine which loyalty program the user or the transaction is eligible for. The universal loyalty program determines the eligibility automatically, and may be more efficient than the user in doing so, as some transactions may be eligible for multiple loyalty programs. The universal loyalty program can update all the necessary individual loyalty programs, and/or determine which loyalty program has the best rewards for the specific transaction.

Other conveniences to the user include the universal loyalty program providing a centralized and networked interface for the user to view, update, and manage all the individual loyalty programs in one place.

Other advantages may include providing valuable transaction and account history data to participating merchants. As mentioned before, the reports generated by the universal loyalty program may be used to help merchants target their marketing or advertising techniques, and provide targeted rewards and incentives to their customers. Merchants may also analyze transactions with other competing merchants, or other associated merchants to negotiate reward partnerships. The transaction data gathered and generated by the universal loyalty program may be used for a wide variety of business purposes to its participating merchants.

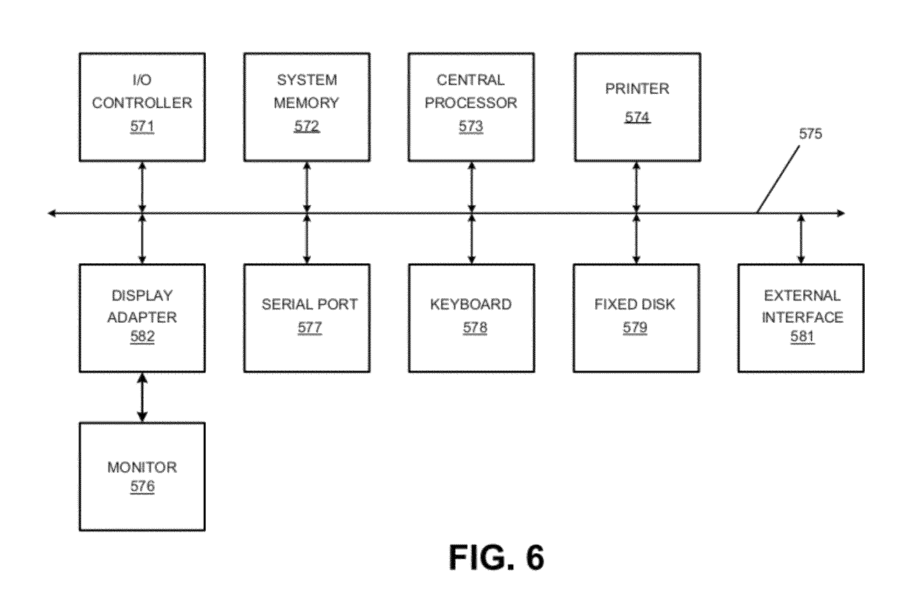

FIG. 6 shows an exemplary computer apparatus, which may be implemented in any embodiment of the disclosure, by the user, merchant, universal loyalty program, acquirer, issuer, payment processing network, and/or any other entity involved therein.

Specific details regarding some of the above-described aspects are provided. The specific details of the specific aspects may be combined in any suitable manner without departing from the spirit and scope of embodiments of the disclosure.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network. For the purposes of this disclosure, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes any physical or material medium which can be used to tangibly store the desired information or data or instructions and which can be accessed by a computer or processor.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

A recitation of “a”, “an” or “the” is intended to mean “one or more” unless specifically indicated to the contrary.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

All patents, patent applications, publications, and descriptions mentioned above are herein incorporated by reference in their entirety for all purposes. None is admitted to be prior art.

What is claimed is:

1. A method of implementing a universal loyalty program performed by a computing device executing software, the method comprising:
issuing, by the computing device, a universal loyalty program account to a user;
receiving, by the computing device, a plurality of loyalty program identifiers of the user for a plurality of loyalty programs associated with a plurality of participating merchants;
storing data associating by the computing device, the plurality of loyalty program identifiers with the universal loyalty program account; and
determining, by the computing device, a corresponding loyalty program identifier when a transaction in the universal loyalty program account occurs at a participating merchant based on the data associating the loyalty program identifiers with the universal loyalty program account.

2. The method of claim 1, further comprising initiating, by the computing device, a real-time promotion to the universal loyalty program account based on purchase details of the user received from the plurality of loyalty programs.

3. The method of claim 2, further comprising providing, by the computing device, a real-time update to the universal loyalty program account.

4. The method of claim 3, wherein the real-time update comprises accruing rewards to the corresponding loyalty program associated with the participating merchant, and accruing rewards to a further loyalty program based on the transaction in the universal loyalty program account.

5. The method of claim 1, wherein the universal loyalty program account and plurality of loyalty program identifiers are stored on a universal loyalty program device, the universal loyalty program device comprising one or more of a payment card, a key fob, and a loyalty program card.

6. The method of claim 1, further comprising:
receiving, by the computing device, a plurality of payment card identifiers; and
storing data associating, by the computing device, the plurality of payment card identifiers with the universal loyalty program account.

7. The method of claim 1, further comprising:
recording, by the computing device, transaction data for transactions made using the universal loyalty program account; and
providing, by the computing device, transaction data of the corresponding loyalty program to the associated participating merchant.

8. The method of claim 1, further comprising providing, by the computing device, data to the participating merchant to enable the participating merchant to target offers to the user.

9. A method of conducting a purchase transaction with a universal loyalty program, performed by a computing device executing software, the method comprising:
registering, by the computing device, a plurality of participating loyalty programs associated with a plurality of participating merchants to a universal loyalty program account;
registering, by the computing device, a plurality of payment devices to the universal loyalty program account; and
determining, by the computing device, real-time promotions from a corresponding loyalty program in the plurality of participating loyalty programs when a payment device in the plurality of payment devices registered to the universal loyalty program is used in a transaction with a participating merchant.

10. The method of claim 9, further comprising automatically accruing rewards based on the transaction.

11. The method of claim 10, further comprising completing the transaction with the participating merchant using a payment account identified by the payment device.

12. The method of claim 11, wherein completing the transaction further comprises redeeming rewards accumulated in at least one of the participating loyalty programs as at least a portion of a payment for the transaction.

13. The method of claim 11, wherein the rewards are accrued to the corresponding loyalty program associated with the participating merchant determined by the transaction.

14. The method of claim 11, wherein the rewards are accrued to the universal loyalty program associated with the registered payment device.

15. The method of claim 11, further comprising:
providing a user interface to allow a user to selectively link one or more of the plurality of loyalty programs to one or more of the plurality of payment devices;
storing data linking at least one of the payment devices to at least one of the loyalty programs;
receiving an authorization request message for the at least one payment device linked to the at least one loyalty program; and
updating the at least one of the loyalty programs according to the data linking the at least one of the payment devices to the at least one of the loyalty programs, after receiving the authorization request message.

16. A non-transitory computer readable storage medium storing computer program instructions configured in one or more sequences to instruct a computer processor to:
issue, by the computer processor, a universal loyalty program account to a user;
receive, by the computing processor, a plurality of loyalty program identifiers of the user for a plurality of loyalty programs associated with a plurality of participating merchants;
store data associating, by the computing processor, the plurality of loyalty program identifiers with the universal loyalty program account; and
determine, by the computing processor, a corresponding loyalty program identifier when a transaction in the universal loyalty program account occurs at a participating merchant based on the data associating the loyalty program identifiers with the universal loyalty program account.

17. A universal loyalty program computer having the non-transitory computer readable storage medium of claim 16, further comprising:
the computer processor coupled with the non-transitory computer readable storage medium.

18. The universal loyalty program computer of claim 17, wherein the corresponding loyalty program identifier identifies the user as a member in a corresponding loyalty program hosted on a computer system separately from the universal loyalty program computer.

19. The universal loyalty program computer of claim 18, wherein the corresponding loyalty program has a plurality of members different from the user; and the plurality of members are not in the universal loyalty program.

20. The universal loyalty program computer of claim 19, wherein the instructions is further configured to instruct the computing device to receive purchase details of the transaction from the participating merchant and apply the purchase details to a further loyalty program in the plurality of loyalty programs.
